(19) United States
(12) Patent Application Publication
(10) Pub. No.: US 2007/0154376 A1
(43) Pub. Date: Jul. 5, 2007

(54) Purification of sulfuryl fluoride

(75) Inventor: Christoph Sommer, Neckarsulm (DE)

Correspondence Address: CONNOLLY BOVE LODGE & HUTZ, LLP, P O BOX 2207, WILMINGTON, DE, 19899, US

(73) Assignee: Solvay Fluor GmbH, Hannover (DE)

(21) Appl. No.: 10/591,554

(22) PCT Filed: Feb. 9, 2005
(86) PCT No.: PCT/EP05/01282

§ 371 Date: Oct. 9, 2006

(30) Foreign Application Priority Data
Mar. 4, 2004 (EP) 04005084.1

(51) Int. Cl. C01B 31/20; C01B 17/16

(52) U.S. Cl. 423/220

(57) ABSTRACT

Sulphuryl fluoride may comprise carbon dioxide. It has now been found that the carbon dioxide can be removed from the sulphuryl fluoride by means of molecular sieve.

The invention relates to a process for purifying sulphuryl fluoride by means of molecular sieve for the purpose of removing carbon dioxide.

As a result of the preparation or use, sulphuryl fluoride may comprise, inter alia, sulphur dioxide, hydrogen fluoride, hydrogen chloride, organic compounds and/or carbon dioxide.

Sulphur dioxide and, where present, sulphuryl chloride fluoride may be removed, for example, by means of alumina; see WO 03/066520. By means of alkali metal fluoride, e.g. KF, it is possible to remove hydrogen fluoride in particular. This is disclosed in DE-A 101 11 302, which also contains the indication that adsorbents, preferably activated carbon, zeolite and/or silica gel, might additionally be present, with whose aid water, halogens and organic compounds would be removable.

It is an object of the present invention to provide a process by means of which carbon dioxide which is present in sulphuryl fluoride can be removed. This object is achieved by the process of the present invention.

The process according to the invention for removing carbon dioxide from sulphuryl fluoride envisages that the carbon dioxide-containing sulphuryl fluoride is contacted with molecular sieve of a pore size of 4 Å (0.4 nm). In this way, the content of carbon dioxide can be reduced down to values which are below the detection limit of the GC method.

The process can be carried out batchwise or continuously. Alternating adsorption is possible. In this case, a plurality of adsorbent towers are used which are operated in alternation in the adsorption/regeneration.

The removal of CO₂ can be carried out at ambient temperature. However, it is also possible to carry out the removal at higher or lower temperature, for example in the range of 0° C. and 40° C. or more.

The pressure at which the removal of the carbon dioxide is carried out is likewise not critical. The process can be carried out, for example, from 1 bar (abs.) to 11 bar (abs.), for example also at ambient pressure. Advantageously, the range from 1 bar (abs.) to 2 bar (abs.) is employed.

The molecular sieve used is advantageously type A 4 Å molecular sieve, preferably in the sodium form. It is appropriately in particulate form, for example in sphere form with a diameter in the range up to 10 mm. Very suitable particles are those having a size in the range from 2.5 to 5 mm. Molecular sieve with large internal surface area, for example 500 m²/g and more, has a high adsorption capacity owing to the large cavity volume and the large internal surface area.

When the sulphuryl fluoride comprises SO₂ and/or water, this impurity or these impurities are likewise sorbed.

If desired, the process according to the invention for removing carbon dioxide from sulphuryl fluoride can be combined with other purifying operations. For example, a wet scrubbing can be inserted upstream. By means of the wet scrubbing, the content of SO₂, HF and HCl can be reduced. The effectiveness is improved when alkaline solutions are used; however, this is associated with losses of sulphuryl fluoride by hydrolysis.

In combination with the wet scrubbing, the process according to the invention has the advantage that, in addition to carbon dioxide, any water introduced into the sulphuryl fluoride is also removed.

A combination with other purifying operations is also possible, for example with the process for removing SO₂ and sulphuryl chloride fluoride by means of alumina disclosed in WO 03/066520.

The molecular sieve laden with CO₂ and possibly other impurities and SO₂F₂ can be regenerated. To this end, it is subjected to vacuum and/or elevated temperature, for example 150° C. or higher. An inert gas purge during the desorption, for example with nitrogen, is appropriate.

The process has the advantage that carbon dioxide can be removed from sulphuryl fluoride without simultaneously adsorbing or decomposing sulphuryl fluoride.

The example which follows is intended to further illustrate the invention without restricting its scope.

### EXAMPLE

### Preparation of Low-CO₂ Sulphuryl Fluoride

Molecular Sieve Used:

45 kg of type A 4 Å (=0.4 nm) molecular sieve in the sodium form. TE 146 from UOP was used in the form of binder-free beads having a diameter of from 2.5 to 5 mm; adsorption surface area about 800 m²/g.

Sulphuryl Fluoride to be Purified:

580 kg of sulphuryl fluoride having a liquid phase content of 1.4% by weight of CO₂.

Procedure:

The sulphuryl fluoride was conducted in circulation through the molecular sieve over a period of 60 h. In the gas stream after the adsorption, no CO₂ fractions could be detected any longer. After this time, the CO₂ content of the liquid phase had been reduced to 0.16% by weight. Thus, about 7 kg of CO₂ had been adsorbed by the molecular sieve.

Desorption:

The molecular sieve was regenerated at 200° C. with N₂ purging for 48 h. Thereafter, it was usable again for the adsorption of CO₂ from sulphuryl fluoride.

The process, particularly in the form of an alternating adsorption, is thus found to be a technically simple and inexpensive solution.

1. Process for removing carbon dioxide from sulphuryl fluoride, comprising the step of contacting the carbon dioxide-containing sulphuryl fluoride with 4 Å (=0.4 nm) molecular sieve.

2. Process according to claim 1, characterized in that the process is carried out batchwise or continuously.

3. Process according to claim 1, characterized in that the laden molecular sieve is regenerated.

4. Process according to claim 3, characterized in that it is carried out continuously in alternating operation, such that one or more adsorbers are regenerated and one or more adsorbers are contacted with the sulphuryl fluoride.

5. Process according to claim 1, characterized in that the contacting stage is carried out at a temperature in the range from 0 to 40° C.

6. Process according to claim 1, characterized in that the contacting stage is carried out at a pressure of 1 bar (abs.) to 11 bar (abs.).

7. Process according to claim 1, characterized in that the sulphuryl fluoride is also contaminated with sulphur dioxide and in that at least a portion of the sulphur dioxide is adsorbed together with the CO₂.

8. Process according to claim 1, characterized in that further purifying operations are additionally carried out to remove impurities from the sulphuryl fluoride.

9. Process according to claim 8, characterized in that a further purifying operation undertaken is a wet or dry purification which is undertaken before the sulphuryl fluoride is contacted with 4 Å molecular sieve.

10. Process according to claim 2, characterized in that the contacting stage is carried out at a temperature in the range from 0 to 40° C. and a pressure of 1 bar (abs.) to 11 bar (abs.).
